(19) United States
(12) Patent Application Publication
(10) Pub. No.: US 2020/0197984 A1
(43) Pub. Date: Jun. 25, 2020

(54) WORKPIECE WASHER FOR BLIND HOLES

(71) Applicant: Ingersoll-Rand Industrial U.S., Inc., Davidson, NC (US)

(72) Inventor: Mark E. Mcilrath, Mooresville, NC (US)

(21) Appl. No.: 16/721,342

(22) Filed: Dec. 19, 2019

Related U.S. Application Data
(60) Provisional application No. 62/782,038, filed on Dec. 19, 2018.

(51) Int. Cl. B08B 9/00; B05B 15/65; B05B 15/68

(52) U.S. Cl. CPC B08B 9/00; B05B 15/68; B05B 15/65

(57) ABSTRACT

A washer for a work piece includes a spray nozzle and plunger useful to activate the spray nozzle. The spray nozzle is configured and positioned to remove very small debris and can be positioned within a housing to accommodate different types of work pieces. The plunger can include a recess for receipt and centering of the work piece. A position of the plunger can activate a switch useful to control the introduction of fluid to the spray nozzle. The plunger can be coupled with an elastic device useful to return the plunger to a home position after insertion of the work piece.

### TECHNICAL FIELD

The present invention generally relates to devices useful to wash debris from manufactured parts, and more particularly, but not exclusively, to washers useful to remove debris from shaft centers, end taps and other blind holes.

### BACKGROUND

Providing systems useful to clean parts of very small debris in hard to reach areas remains an area of interest. Some existing systems have various shortcomings relative to certain applications. Accordingly, there remains a need for further contributions in this area of technology.

### SUMMARY

One embodiment of the present invention is a unique part washer for removal of small debris. Other embodiments include apparatuses, systems, devices, hardware, methods, and combinations for removing small debris from hard to reach areas of machined parts. Further embodiments, forms, features, aspects, benefits, and advantages of the present application shall become apparent from the description and figures provided herewith.

### BRIEF DESCRIPTION OF THE FIGURES

FIG. 1 depicts an embodiment of a washer.

FIG. 2 depicts an embodiment of a washer coupled with another washer.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

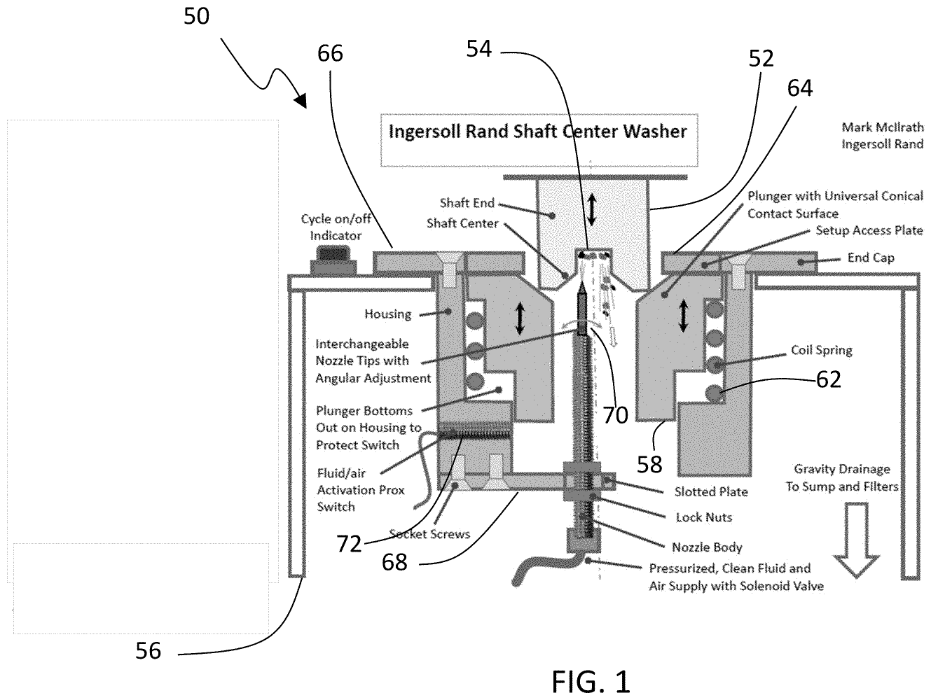

With reference to FIG. 1, a washer 50 is disclosed in which can be used to wash components. For example, the washer 50 can be used to wash precision products such as machined shafts that are highly sensitive to debris (an example of such a work piece is depicted as reference numeral 52). To set forth just a few non-limiting examples, shaft centers, end taps and other blind holes can trap debris created during the machining process (an example of a hard to reach area is shown as reference numeral 54). Such debris can be on the order of single digit microns, but larger debris is also contemplated that may be present and may be washed via the washer 50. Because of the location and aspect ratio of the internal surface holding the debris, standard washing from radial or oblique directions can be ineffective. A novel washing system is needed to clean this area to precision standards.

The washer 50 includes a housing 56 that can be a single unitary housing or can be fastened together from constituent components (e.g. sides, top, etc). The housing 56 can be used to support various internal components such as a plunger 58 and plunger base 60. The plunger 58 can be coupled to the plunger base 60 through any suitable elastic device 62 such as a spring, elastomer, etc. Depicted in the illustrated embodiment is a coil spring. The plunger 58 is capable of moving relative to the housing 56 upon contact with the work piece 52. As the work piece 52 is urged toward an interior of the housing 56 the plunger can move in reaction to it. When the work piece 52 is removed action of the elastic device 58 can be used to return the plunger 58 to a resting position.

The plunger 58 can take a variety of forms and be made from a variety of materials. In one embodiment the plunger 58 includes a conical shaped engagement surface which is sized large enough to receive the work piece 52. Other shapes are also contemplated. The conical shaped engagement surface is used to assist in centering the work piece when it engages the plunger 58. In one form the conical surface is angled at 45 degrees, but other angles are also contemplated whether steeper or shallower than 45 degrees. The plunger 58 can include an abutment surface to engage the plunger base 60 to stop further inward motion.

A setup access plate 64 can be provided to assist in closing off an interior of the housing 56 and/or provide a stop for movement of the plunger 58, and/or permit entry to the interior of the housing 56 for servicing of the washer 50. The setup access plate 64 can take any variety of forms including a threaded plate, a plate with bayonet type connections, etc. It is contemplated that in some embodiments the setup access plate 64 may require minimal turning to permit access to the interior of the housing 56. In some alternative and/or additional forms the setup access plate 64 may be secured in place via threaded connectors such as screws, bolts, etc.

The housing 50 can also include an end cap 66 to further close off the interior of the housing 50 and/or provide support for the plunger base 60. The end cap 66 can be an integral part of the housing 56, but in some forms the end cap 66 can be a separately made component that is attached to the housing 56. In some forms the end cap 66 can be fastened to the housing via mechanical fasteners, but other forms of attachment are also contemplated such as bonding, etc.

A support plate 68 can be provided which is used to mount a nozzle 70. The support plate 68 can be attached to the plunger base 60, but other connections are also contemplated, including direct connection to the housing 56. The support plate 68 includes a slotted portion within which the nozzle body can be slidingly moved to change a position of the nozzle 70. The slotted portion can be oriented in the radial direction, but other directions are also contemplated. In the illustrated embodiment the nozzle body includes a threaded portion which engages a pair of lock nuts useful to lock the nozzle body in place. The lock nuts can be loosened to permit adjustment of the nozzle body to a different position to accommodate a different work piece 52. In some forms only one lock nut need be provided. In still further forms other techniques can be used to position the nozzle body, including pre-formed holes into which the nozzle body is inserted, etc.

The nozzle 70 can take on a variety of forms and include a number of features. In one form the nozzle 70 includes a single orifice from which fluid is sprayed toward the work piece 52, but other embodiments can include a nozzle having a plurality of orifices. The orifice(s) can be oriented in an axial direction, but in other forms such orifice(s) can be angled away from the axial direction. The orifices can be sized for example having ⅛″ diameter, but other sizes are also contemplated. In some forms the orifice(s) can be circular, but other shapes are also contemplated. In those embodiments having more than one orifice, the orifices can have the same shape, size, and orientation, but differences of shape, size, and orientation among the orifices is also contemplated. The nozzle 70 is capable of being pivoted as depicted in the figure. In some forms such pivot can be restrained within a plane of rotation, but other forms the nozzle 70 can be pivoted about a point but allowed to rotate out of a single plane. The nozzle 70 can provide a variety of spray patterns. Such spray patters can either narrow or wide cones, and can provide a range of fluid velocities depending on back pressure, nozzle shape/size/configuration/etc. When liquid is used as the spray fluid from the nozzle 70, the nozzle 70 can provide droplets in various sizes.

A switch 72 can be provided to activate the process by which fluid can be sprayed from the nozzle 70. The switch 72 can be activated by movement of the plunger 58 and can take on any variety of forms, such as contact or non-contact switches. In one non-limiting embodiment, the switch 72 can be a magnetic switch which reacts to a magnetic device coupled with the plunger 58. In some forms the plunger 58 can be ferromagnetic. When the plunger 58 has made sufficient movement the switch 72 can send a signal or otherwise activate the process by which fluid is sprayed from the nozzle 70.

The washer 50 can further include a cycle indicator 74 useful to indicate when fluid is being sprayed from the nozzle 70. The cycle indicator 74 can be activated by any suitable device (e.g. directly by the switch 72, or indirectly from a controller, for example, which receives information from the switch 72). The cycle indicator 74 can be a visual, auditory, or tactile device. Indications from the cycle indicator 74 can be tied strictly to plunger depth sensed by the switch 72, and/or can provide an indication for a period of time after the switch 72 ceases to detect depth of plunger movement.

The washer 50 further includes a drain (not depicted) and filter system (not depicted) useful to receive and remove debris so that the cleaning fluid used in the nozzle may be recycled for further use. The washer 50 can also include a reservoir of fluid and associated conduits to provide fluid to the nozzle 70. The fluid can take the form of water, air, or a combination of the two. In some forms the washer 50 can also include a controller useful to activate the nozzle 70 upon receipt of a signal from the switch 72. The controller can be comprised of digital circuitry, analog circuitry, or a hybrid combination of both of these types. Also, the controller can be programmable, an integrated state machine, or a hybrid combination thereof. In one form the controller is a programmable logic controller. The controller can include one or more Arithmetic Logic Units (ALUs), Central Processing Units (CPUs), memories, limiters, conditioners, filters, format converters, or the like which are not shown to preserve clarity. In one form, the controller is of a programmable variety that executes algorithms and processes data in accordance with operating logic that is defined by programming instructions (such as software or firmware). Alternatively or additionally, operating logic for the controller can be at least partially defined by hardwired logic or other hardware.

As will be appreciated given the description above, the washer 50 can include all parts needed to detect insertion of the work piece 52, activate a pump and/or valve to form a spray of fluid from the nozzle 70, recovery of spent fluid, filtering of debris, and recycling of the fluid.

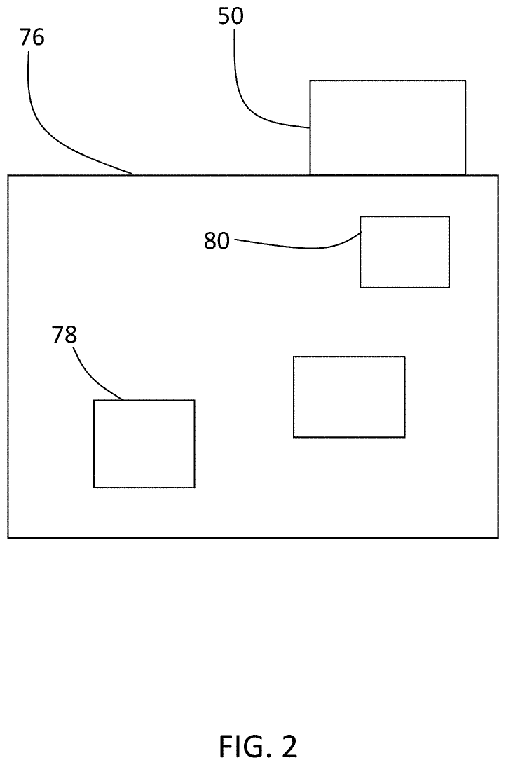

Turning now to FIG. 2, and with continuing reference to FIG. 1, one or more components of the washer 50 described above can be coupled with a larger washer 76 which is also useful to wash the work piece 52. Such larger washer 76 may be used to wash areas of the work piece 52 other than the hard to reach areas described above. The larger washer 76 may include certain components in lieu of the washer 50 such that the washer 50 need include items depicted in FIG. 1.

The washer 50 can be much smaller than the larger washer 76 as depicted in FIG. 2. In some forms the washer 50 can be the size of a shoebox which is connected to the larger washer 76. It is contemplated that the washer 50 and larger washer 76 may be part of a robotic washer system. Such robotic washer system can utilize a robotic arm and/or gripper useful to deliver the work piece 52 to nozzle 70 for application of spray from the nozzle 70, as well as to deliver the work piece 52 to the larger washer 76 for exposure to associated cleaning fluid (whether that cleaning fluid is provided via a spray nozzle or other techniques).

The larger washer 76 can include a controller 78 useful to receive information from the switch 72 and activate one or more devices to cause fluid to flow through the nozzle 70. The controller 78 can also activate the cycle indicator 74.

The spray nozzle 70 can be coupled with a spray manifold 80 useful to collect and/or regulate fluid for delivery from the spray nozzle 70. Such a manifold 80 can take a variety of forms. In one embodiment the spray manifold 80 can be a three way valve useful to select either a gas (e.g. air) or a liquid (e.g. water) for delivery from the nozzle 70. Other arrangements are also contemplated to provide air and liquid as fluids for the nozzle 70, such as separate valves for each of the gas and liquid with a union downstream of the valves prior to introduction out of the nozzle 70. The controller can control whether gas or liquid is flowed through the nozzle 70. For example, the controller can control the frequency that the flow is switched between gas and liquid, the duration of each respective flows of gas and liquid, etc.

Also shown in FIG. 2 is a filter useful to remove debris and other contaminants so that the sprayed fluid can be recycled.

Fluid useful in the spray nozzle 70 can be pressurized using any variety of techniques. In one form fluid in the form of water can be provided from a utility water source with a back pressure provided from the utility, but in other forms liquid can be provided in a reservoir that is itself gravity fed to the nozzle or a gaseous over pressure is provided to pressurize the reservoir. Fluid for use in the nozzle 70 such as a gas can be provided from any suitable pressurization device. In some forms the fluid useful for the spray nozzle 70 can be pumped using any useful type of compressor and/or pump.

An aspect of the present application provides an apparatus comprising a washer useful to remove manufacturing debris from a hole formed in a part, the washer having: a washer housing, a moveable plunger disposed in the housing upon which a part is structured to engage, a switch activated by movement of the moveable plunger, and a spray nozzle positioned to direct a spray of fluid toward the part when the switch is activated by movement of the moveable plunger, wherein the spray nozzle is mounted to a slotted plate disposed within the housing, the slotted plate permitting selective positional adjustment of the nozzle relative to the movable plunger.

A feature of the present application includes wherein the plunger is interconnected to the housing via a spring, the spring structured to provide a restoring force to the plunger when the part is removed.

Another feature of the present application includes wherein the switch is a proximity switch, and wherein the nozzle is mounted to the slotted plate via at least one threaded nut.

Yet another feature of the present application includes wherein the at least one threaded nut can be loosed to permit repositioned of the nozzle at a different location within a slot of the slotted plate.

Still another feature of the present application includes wherein the plunger includes a conical surface into which the part can be received.

Yet still another feature of the present application further includes a setup access plate removeably secured to the housing, the setup access plate structured to be removed when servicing the interior of the washer.

Still yet another feature of the present application includes wherein the setup access plate forms an abutment surface that the plunger engages as a result of spring action from the spring, and which further includes a controller configured to activate the spray nozzle.

A further feature of the present application includes a proximity switch, and wherein the controller is structured to activate at least one valve as a function of a signal from the proximity switch, and wherein the controller is structured to alternate a flow of liquid and a flow of gas through the spray nozzle.

A yet further feature of the present application includes a cycle indicator, wherein the spray nozzle includes a single orifice, wherein the spray nozzle is removeably attached within the washer, and wherein a second spray nozzle can be substituted by removal of the spray nozzle.

A still further feature of the present application includes wherein the housing is attached to a primary spray system having a separate spray cleaning system, and wherein the spray nozzle is positioned off-center of the part and capable of directing the flow of fluid to an off-center portion of the part.

Another aspect of the present application includes an apparatus comprising: a washer having a moveable plunger having an internal reception opening defined by a conical surface into which a workpiece part is structured to engage, a switch activated by movement of the moveable plunger, a spray nozzle positioned to direct a spray of fluid toward the part when the switch is activated by movement of the moveable plunger, and a setup access plate removably secured to the housing and covering an outside portion of the moveable plunger, wherein the setup access plate is structured to be removed when servicing the interior of the washer.

A feature of the present application includes wherein the washer includes a housing, wherein the moveable plunger is interconnected to the housing via a spring, and wherein the spring is structured to provide a restoring force to the moveable plunger when the part is removed.

Another feature of the present application includes wherein the spring is located between an around an outer periphery of the moveable plunger and an inner periphery of a static structure, and wherein the switch is a proximity switch.

Still another feature of the present application includes wherein the nozzle is mounted to a slotted plate.

Yet another feature of the present application includes wherein the nozzle is mounted to the slotted plate via at least one threaded nut that can be loosed to permit repositioned of the nozzle at a different location within a slot of the slotted plate.

Still yet another feature of the present application includes a controller configured to activate the spray nozzle.

Yet still another feature of the present application includes wherein the controller is structured to activate at least one valve to flow a liquid during a first flow mode and to flow a gas during a second flow mode.

A further feature of the present application includes a cycle indicator, and wherein the spray nozzle includes a single orifice.

A still further feature of the present application includes wherein the spray nozzle is removeably attached within the washer, and wherein a second spray nozzle can be substituted by removal of the spray nozzle.

A yet still further feature of the present application includes wherein the housing is attached to a primary spray system having a separate spray cleaning system, and wherein the spray nozzle is positioned off-center of the part and capable of directing the flow of fluid to an off-center portion of the part.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. An apparatus comprising:
a washer useful to remove manufacturing debris from a hole formed in a part, the washer having:
a washer housing;
a moveable plunger disposed in the housing upon which a part is structured to engage;
a switch activated by movement of the moveable plunger; and
a spray nozzle positioned to direct a spray of fluid toward the part when the switch is activated by movement of the moveable plunger;
wherein the spray nozzle is mounted to a slotted plate disposed within the housing, the slotted plate permitting selective positional adjustment of the nozzle relative to the movable plunger.

2. The apparatus of claim 1, wherein the plunger is interconnected to the housing via a spring, the spring structured to provide a restoring force to the plunger when the part is removed.

3. The apparatus of claim 2, wherein the switch is a proximity switch, and wherein the nozzle is mounted to the slotted plate via at least one threaded nut.

4. The apparatus of claim 3, wherein the at least one threaded nut can be loosed to permit repositioned of the nozzle at a different location within a slot of the slotted plate.

5. The apparatus of claim 2, wherein the plunger includes a conical surface into which the part can be received.

6. The apparatus of claim 5, which further includes a setup access plate removeably secured to the housing, the setup access plate structured to be removed when servicing the interior of the washer.

7. The apparatus of claim 6, wherein the setup access plate forms an abutment surface that the plunger engages as a result of spring action from the spring, and which further includes a controller configured to activate the spray nozzle.

8. The apparatus of claim 7, which further includes a proximity switch, and wherein the controller is structured to activate at least one valve as a function of a signal from the proximity switch, and wherein the controller is structured to alternate a flow of liquid and a flow of gas through the spray nozzle.

9. The apparatus of claim 7, which further includes a cycle indicator, wherein the spray nozzle includes a single orifice, wherein the spray nozzle is removeably attached within the washer, and wherein a second spray nozzle can be substituted by removal of the spray nozzle.

10. The apparatus of claim 1, wherein the housing is attached to a primary spray system having a separate spray cleaning system, and wherein the spray nozzle is positioned off-center of the part and capable of directing the flow of fluid to an off-center portion of the part.

11. An apparatus comprising:
a washer having a moveable plunger having an internal reception opening defined by a conical surface into which a workpiece part is structured to engage, a switch activated by movement of the moveable plunger, a spray nozzle positioned to direct a spray of fluid toward the part when the switch is activated by movement of the moveable plunger, and a setup access plate removably secured to the housing and covering an outside portion of the moveable plunger, wherein the setup access plate is structured to be removed when servicing the interior of the washer.

12. The apparatus of claim 11, wherein the washer includes a housing, wherein the moveable plunger is interconnected to the housing via a spring, and wherein the spring is structured to provide a restoring force to the moveable plunger when the part is removed.

13. The apparatus of claim 12, wherein the spring is located between an around an outer periphery of the moveable plunger and an inner periphery of a static structure, and wherein the switch is a proximity switch.

14. The apparatus of claim 13, wherein the nozzle is mounted to a slotted plate.

15. The apparatus of claim 14, wherein the nozzle is mounted to the slotted plate via at least one threaded nut that can be loosed to permit repositioned of the nozzle at a different location within a slot of the slotted plate.

16. The apparatus of claim 11, which further includes a controller configured to activate the spray nozzle.

17. The apparatus of claim 16, wherein the controller is structured to activate at least one valve to flow a liquid during a first flow mode and to flow a gas during a second flow mode.

18. The apparatus of claim 16, which further includes a cycle indicator, and wherein the spray nozzle includes a single orifice.

19. The apparatus of claim 11, wherein the spray nozzle is removeably attached within the washer, and wherein a second spray nozzle can be substituted by removal of the spray nozzle.

20. The apparatus of claim 11, wherein the housing is attached to a primary spray system having a separate spray cleaning system, and wherein the spray nozzle is positioned off-center of the part and capable of directing the flow of fluid to an off-center portion of the part.
